(19) United States
(12) Patent Application Publication
(10) Pub. No.: US 2008/0163648 A1
(43) Pub. Date: Jul. 10, 2008

(54) Glass Panel

(76) Inventors: Ronald Lee Sundholm, Milwaukie, OR (US); Karen Irene Miller, Portland, OR (US); Yvette Clark, Portland, OR (US)

Correspondence Address: Ron Sundholm, 16940 SE Azalea Drive, Milwaukie, OR, 97267, US

(21) Appl. No.: 11/621,100

(22) Filed: Jan. 8, 2007

(51) Int. Cl. C03B 8/02

(52) U.S. Cl. 65/17.2; 428/38

(57) ABSTRACT

Glass panels are manufactured from cracked windshields and other pieces of safety glass. Manufacturing glass panels from cracked safety glass prevents the cracked safety glass from being placed into landfills. The method of manufacturing glass panels from cracked safety glass does not require melting the glass and thus provides a low energy solution for recycling cracked safety glass.

### CROSS-REFERENCE TO RELATED APPLICATIONS

Not applicable.

### STATEMENT REGARDING FEDERALLY SPONSORED RESEARCH

Not applicable.

### REFERENCE TO SEQUENCE LISTING

Not applicable.

### FIELD OF THE INVENTION

The present invention relates to glass panels, and particularly to glass panels constructed from recycled safety glass. The present invention also relates to a method for recycling safety glass into glass panels.

### BACKGROUND OF THE INVENTION

Safety glass, which is formed by sandwiching a polymer sheet between two layers of glass, is used in many applications such as vehicle windshields and in buildings for windows and walls where transparency is desirable, but strength and protection from shattered shards of glass is necessary. When safety glass is impacted one or both layers of glass often break, but the polymer between the glass layers holds the shards in place. The polymer sheet also adds strength to the safety glass making the safety glass difficult to break through, even when one or both glass layers are broken.

After safety glass has been impacted and one or both glass layers are broken the safety glass is replaced with new safety glass. The shattered safety glass, which is still held together by the polymer sheet, is either thrown away and ends up in a landfill, or is recycled by melting the safety glass and forming another glass product from the molten glass.

Many tons of used vehicle windshields generally end up in the nation's landfills. Due to their laminated construction, they do not readily avail themselves to current recycling concepts. The problem with discarding impacted safety glass is that it does not decompose and thus takes up space in a landfill for an extremely long time. Discarded impacted safety glass is also expensive to process due to the time and energy it takes to move the impacted safety glass to a landfill.

While melting impacted safety glass to form new glass products eliminates placing the impacted safety glass into a landfill, it still requires a large amount of energy to heat the impacted safety glass to a point where the glass melts. In addition to requiring large amounts of energy to recycle impacted safety glass in such a manner, the polymer sheet is vaporized and its particles enter the atmosphere due to the heat required to melt the glass.

### BRIEF SUMMARY OF THE INVENTION

There is a need to prevent impacted safety glass from being discarded and taking up space in landfills. There is also a need for a glass product that uses impacted safety glass without requiring large amounts of energy to process. The present invention overcomes the inability of prior safety glass recycling methods and products to recycle impacted safety glass without requiring large energy consumption.

An object of the invention is to utilize used windshields prior to ending up in a landfill—to recycle this non-biodegradable material to produce a usable end product. Another object of the invention is to produce a usable, decorative, finished product that can be cut to desired size for use in homes, condominiums, offices and restaurants for decorative and functional uses, for example, such as shower doors, partitions, panels and tiles.

Embodiments of the present invention meet this need, and others, by using impacted safety glass to form glass panels. The glass panels can be used for any application where a flat surface is desired and the inventive glass panel provides the requisite strength or other desired property. Embodiments of the inventive glass panels are formed from impacted safety glass which is encapsulated in a transparent resin. Other embodiments of the inventive glass panels are formed from impacted safety glass which has been further impacted to flatten the safety glass before being encapsulated in resin.

Yet other embodiments of the present invention relate to a method for making glass panels from impacted safety glass. Impacted safety glass is cleaned, and flattened, if necessary. In certain embodiments, a colorant is placed on at least a portion of one surface of the impacted safety glass. The colorant may be left in place on the surface, or removed so that only colorant remains in the cracks in the safety glass. The impacted safety glass is heated to a temperature where the colorant bonds or sets. The impacted safety glass is then cut or trimmed to a desired shape. A mold having the desired shape and being slightly larger than the cut or trimmed impacted safety glass is partially filled with a resin. The resin is allowed to partially set before the cut or trimmed impacted safety glass is placed in the mold. More resin is then poured into the mold to cover the sides and exposed surface of the impacted safety glass. Once the resin has set the glass panel is removed from the mold and is ready for use. The present invention has advantages over the prior art and makes a technical contribution by providing a low-cost, energy-saving method of manufacturing glass products directly from used vehicle windshields or other used safety glass products.

### BRIEF DESCRIPTION OF THE DRAWINGS

The present invention is illustrated by way of example, and not by way of limitation in the figures of the accompanying drawings in which like reference numerals refer to similar elements and in which:

FIG. 1 is a top view of a preferred embodiment of the present invention.

FIG. 2 is a side view of the embodiment of FIG. 1.

FIG. 3 is a top perspective view of the embodiment of FIG. 1.

FIG. 4 is a block diagram view of a preferred method for making a glass panel.

### DETAILED DESCRIPTION

The present invention addresses and solves problems related to recycling cracked safety glass, such as, but not limited to, automobile windshields, particularly where current recycling methods require large amounts of energy to melt the safety glass. The present invention also addresses and solves problems related to providing decorative glass panels useful for a variety of applications ranging from interior decorating to tiles to trivets.

The present invention solves the above problems by providing a method for manufacturing glass panels as discussed below. One of ordinary skill in the art will realize that the following discussion is illustrative and intended to describe preferred embodiments of the present invention and is not intended to limit the present invention to the embodiments discussed. The present invention has numerous applications where a glass panel may be used. The present invention may be scaled and adapted to many applications and is defined by the claims, which set forth the metes and bounds of the present invention.

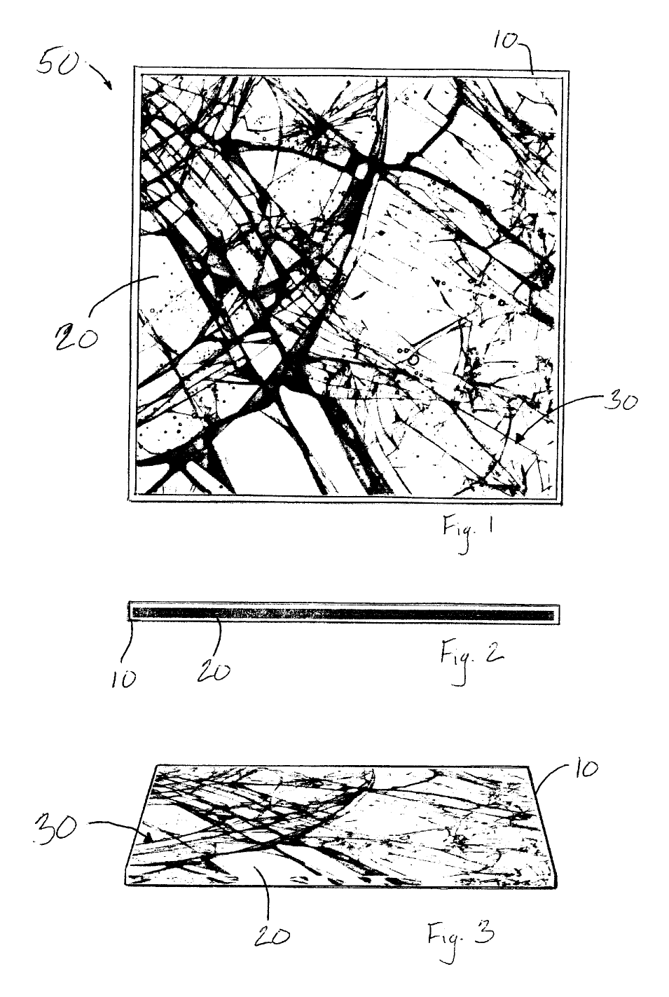

Referring now to the drawings, and initially to FIG. 1, an improved glass panel is described. As is well known in the art, a piece of safety glass 20 is originally manufactured by placing a polymer between two sheets of glass. Safety glass 20 has a range of uses including vehicle windshields, as barriers preventing entry into a building and other applications where it is desirable to have glass that is difficult to break and does not result in loose shards of glass when it does break. Due to the applications safety glass 20 is used for, safety glass 20 has a high likelihood of being struck and becoming cracked. Cracked safety glass 20 is normally thrown away, ending up in a landfill, or may be recycled by melting the safety glass 20 into a new glass product.

As discussed above, throwing safety glass 20 away and melting safety glass 20 both have undesirable environmental impacts. The inventive glass panel 50 solves these problems.

Glass panel 50 is made from a piece of safety glass 20 which has been cracked. In the case of vehicle windshields, which are curved, it is desirable to flatten the cracked safety glass 20. This is done, preferably, by passing the safety glass between two rollers, which further cracks the safety glass 20. Other manners for flattening the safety glass 20 and further cracking the safety glass 20 are within the scope of the present invention. The polymer layer in safety glass 20 holds the cracked glass sheets together.

In a preferred embodiment, a transparent resin 10 encases the cracked sheet of safety glass 20. Additionally, a colorant 30 can be added to the cracks in the safety glass 20 before the resin 10 is applied. In other embodiments, the colorant 30 is applied to one of the large surfaces of safety glass 20 and remains in place under the resin 10. In still other embodiments the colorant 30 is placed on multiple sides of safety glass 20 and remains in place under resin 10.

As seen in FIG. 2, the resin 10 completely surrounds the safety glass 20. In a preferred embodiment, the resin 10 is approximately ⅛ of an inch thick on all six sides of the safety glass 20. The resin 10 and the polymer layer of the safety glass 20 provide the structural support for the finished glass panel 50.

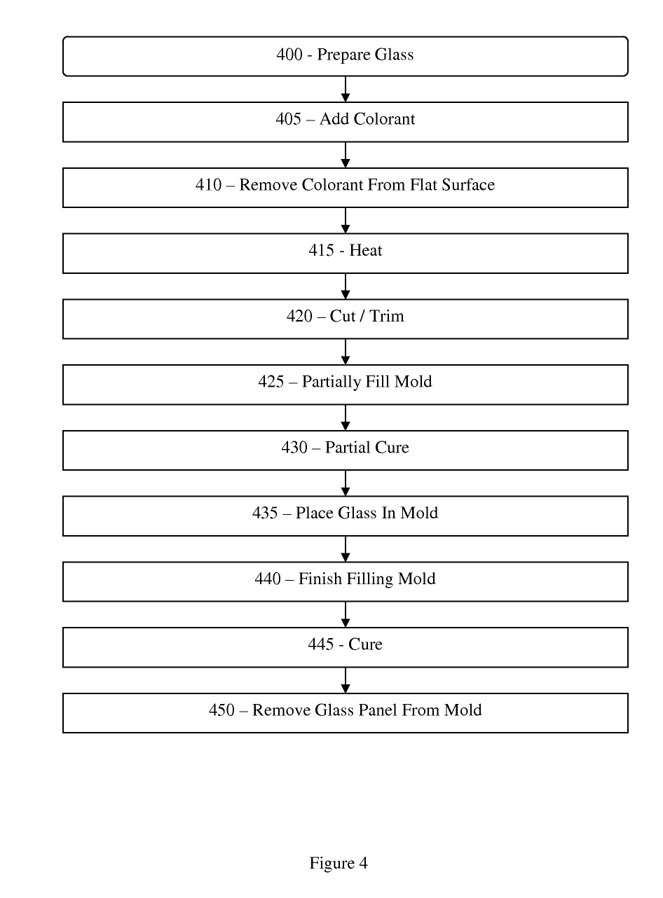

Referring now to FIG. 4, a preferred method for making a glass panel 50 is described. At step 400 a piece of safety glass is cleaned, then cracked by moving the piece of safety glass between two rollers. In the preferred method, using two rollers provides additional cracking for the safety glass and, in the case of vehicle windshields which are often curved, flattens the piece of safety glass. Other manners for cracking or flattening safety glass such as impacting the safety glass or moving one roller over the safety glass, for example, are contemplated and fall within the scope of the present invention. Cracking or flattening the safety glass may not be necessary depending upon the condition of the safety glass when it is received for remanufacture.

A colorant is added to the safety glass at step 405. In the preferred embodiment, a liquid dye is used as the colorant—and specifically Jacquard brand liquid dyes—and is applied using a paint roller. Other colorants, by way of example and not limitation, such as paints—oil, water-based or otherwise—and inks are contemplated and fall within the scope of the present invention. The colorant may be added to one or more sides of the cracked safety glass.

Step 410 is an optional step depending upon the aesthetic effect sought. If colorant was added to one or more sides of the cracked safety glass and it is desirable to only have colorant within the cracks, then the colorant is removed—by wiping for example, or using a squeegee—from all sides of the cracked safety glass. If it is desirable to leave one or more sides of the cracked safety glass coated with the colorant then step 410 is not performed for the side where it is desirable to leave colorant.

At step 415 the safety glass is heated to set the colorant. In the preferred embodiment the safety glass is heated to 120° Fahrenheit and held at that temperature for ten minutes. The temperature and time will vary according to the colorant used and the amount of bonding or setting for the colorant desired.

The safety glass is then cut to size at step 420. In the preferred embodiment, the safety glass is cut to a size where it will fit within a mold and leave approximately ⅛ of an inch of space on all sides so that resin can surround the cut safety glass while it remains in the mold.

The mold is partially filled with a flowable, substantially transparent material at step 425. In the preferred embodiment, the flowable, substantially transparent material is the high gloss finish resin having the trade name Envirotech Light made my Environmental Tech., Inc. The flowable, substantially transparent material also preferably fills the bottom of the mold to a depth of approximately ⅛ of an inch.

The flowable, substantially transparent material is allowed to partially cure at step 430 before the cut safety glass is placed into the mold at step 435.

At step 440, the mold containing the cut piece of safety glass is filled with flowable, substantially transparent material so that the flowable, substantially transparent material surrounds the cut piece of safety glass with a thickness of approximately ⅛ of an inch on all sides.

The flowable, substantially transparent material is allowed to cure at step 445. In the preferred embodiment, curing is accomplished by allowing the resin to have atmospheric contact for approximately 48 hours. Curing other flowable, substantially transparent materials will differ depending upon the flowable, substantially transparent materials' properties.

The finished glass panel 50 is then removed from the mold at step 450. In the preferred embodiment, the mold is made from a flexible material, such as sheet metal or silicon, so that removing the finished glass panel 50 is accomplished by flexing the mold.

Alternate embodiments of the present inventive method involve forming a glass panel as discussed above, then cutting the glass panel for a specific application—such as a shower door, tile or architectural panel.

While this invention has been described in connection with what is presently considered to be the most practical and preferred embodiment, it is to be understood that the invention is not limited to the described embodiments, but, on the contrary, is intended to cover various modifications and equivalent arrangements included within the scope of the appended claims.

What is claimed is:

1. A glass panel comprising:
a substantially flat, cracked sheet of safety glass encased in a substantially transparent material.

2. The glass panel according to claim 1, further comprising:
a colorant substantially contained within the cracks.

3. The glass panel according to claim 1 further comprising:
a colorant on at least one side of the substantially flat, cracked sheet of safety glass.

4. The glass panel according to claim 2, further comprising:
a colorant on at least one side of the substantially flat, cracked sheet of safety glass.

5. The glass panel according to claim 1 wherein the substantially transparent material is a resin.

6. The glass panel according to claim 5 wherein the encasing resin is approximately ⅛ of an inch thick on all six sides of the substantially flat, cracked sheet of safety glass.

7. The glass panel according to claim 2 wherein the colorant is selected from the group comprising paint, liquid dye, and ink.

8. A glass panel comprising:
a substantially flat, cracked sheet of safety glass encased in a substantially transparent resin that is approximately ⅛ of an inch thick on all six sides of the substantially flat, cracked sheet of safety glass; and
at least a dye substantially contained within the cracks.

9. The glass panel according to claim 8, further comprising:
at least a colorant on at least one side of the substantially flat, cracked sheet of safety glass.

10. A method for making a glass panel comprising the steps of:
cracking a sheet of safety glass;
placing a flowable, substantially transparent material into a mold to partially fill the mold;
trimming the sheet of safety glass to fit within the mold;
placing the cracked sheet of safety glass into the mold that contains the flowable, substantially transparent material;
covering the cracked sheet of safety glass with additional flowable, substantially transparent material;
curing the flowable, substantially transparent material so it becomes solid; and
releasing the finished glass panel from the mold.

11. The method according to claim 10, further comprising the steps of:
placing a colorant on at least one side of the cracked sheet of safety glass; and
heating the cracked sheet of safety glass with the colorant.

12. The method according to claim 11, further comprising the step of:
wiping the colorant from the surface of the at least one side of the cracked sheet of safety glass prior to heating.

13. The method according to claim 10 wherein the flowable, substantially transparent material is a resin.

14. The method according to claim 11, wherein the colorant is selected from the group comprising paint, liquid dye and ink.

15. The method according to claim 11, wherein the step of heating the cracked sheet of safety glass with the colorant is carried out to 120° Fahrenheit and held at 120° Fahrenheit for ten minutes.

16. The method according to claim 10, wherein the mold is flexible.

17. The method according to claim 16, wherein the mold is made from silicon.

18. The method according to claim 10, wherein the step of placing a flowable, substantially transparent material into a mold to partially fill the mold is performed so that the flowable, substantially transparent material is approximately ⅛ of an inch deep; and
wherein the step of covering the cracked sheet of safety glass with additional flowable, substantially transparent material is performed so that the cracked sheet of safety glass is surrounded on all sides by approximately ⅛ of an inch of the flowable, substantially transparent material.

19. The method according to claim 10, wherein the step of cracking a sheet of safety glass is at least partially performed by passing the sheet of safety glass between two rollers.
